(19) United States
(12) Patent Application Publication
(10) Pub. No.: US 2005/0033796 A1
(43) Pub. Date: Feb. 10, 2005

(54) Online autonomic operations guide

(75) Inventors: Allen M. Gilbert, Austin, TX (US); David Louis Kaminsky, Chapel Hill, NC (US); Balachandar Rajaraman, Morrisville, NC (US)

Correspondence Address: CHRISTOPHER & WEISBERG, PA, 200 E. LAS OLAS BLVD, SUITE 2040, FT LAUDERDALE, FL, 33301, US

(73) Assignee: International Business Machines Corporation, Armonk, NY (US)

(21) Appl. No.: 10/635,586

(22) Filed: Aug. 6, 2003

(51) Int. Cl. G06F 15/16

(52) U.S. Cl. 709/200

(57) ABSTRACT

A system, method and apparatus for enforcing the administration policy of a system. The method can include receiving a request to perform an administrative task directed to a resource within a computing network. Responsive to receiving the request, an administration policy including a set of rules for governing the administrative task can be retrieved as can state data for the resource. Subsequently, the retrieved policy can be applied to the retrieved state data. Consequently, the administrative task can be permitted only if the retrieved state data satisfies the set of rules in the retrieved policy.

### BACKGROUND OF THE INVENTION

1. Statement of the Technical Field

The present invention relates to the field of network computing administration and more particularly to network administration using policy based management.

2. Description of the Related Art

The task of modern network administration differs significantly from that of days gone by. Not just a decade ago, network administration primarily entailed the addition and deletion of network users, the management of print queues, and the supervision and operation of daily backup procedures. Most if not all resources required by network applications remained present in the network itself, and few if any network applications depended upon the operation of other, co-executing applications. In fact, the notion of an enterprise application, as compared to a mere network application remained largely within the realm of academia as a decade ago, the enabling technologies had not advanced enough in terms of speed and reliability to facilitate true enterprise computing.

Much has changed since the early days of network computing. Today, enterprise computing permeates the electronic landscape. While some enterprise applications remain largely stand-alone, most rely in some respect on a co-existing enterprise application or a soft enterprise resource, such as a database application, Web application server, or other cooperating component. Thus, the administration of the system has advanced far beyond user and print queue administration and daily backup routines. Today, the interdependencies among network components presents a significant challenge to the administrator. In this regard, the management of a single network component can depend upon the state of a multiplicity of other network components.

The task of network management recently has grown to include policy based management principles. Policy based management principles initially included rules for authentication only. Specifically, the rules specified which users defined within the network were permitted to perform which administrative tasks upon which network components. Typically, the authority to perform such administrative tasks represents the sole type of rule managed by policy within the enterprise. Yet, more recent policy based management principles relate more specifically to differentiated service according to the terms of a service level agreement (SLA). Nevertheless, policy based management principles have not addressed other aspects of network administration—particularly those aspects of network administration related to the interoperability of separate, but interdependent resources, and the ability of the enterprise to behave autonomically, or at least partially autonomically.

In the famed manifesto, Autonomic Computing: IBM's Perspective on the State of Information Technology, Paul Horn, Senior Vice President of IBM Research, observed, “It's not about keeping pace with Moore's Law, but rather dealing with the consequences of its decades-long reign.” Given this observation, Horn suggested a computing parallel to the autonomic nervous system of the biological sciences. Namely, whereas the autonomic nervous system of a human being monitors, regulates, repairs and responds to changing conditions without any conscious effort on the part of the human being, in an autonomic computing system, the system must self-regulate, self-repair and respond to changing conditions, without requiring any conscious effort on the part of the computing system operator.

Thus, while the autonomic nervous system can relieve the human being from the burden of coping with complexity, so too can an autonomic computing system. Rather, the computing system itself can bear the responsibility of coping with its own complexity. The crux of the IBM manifesto relates to eight principal characteristics of an autonomic computing system:

I. The system must “know itself” and include those system components which also possess a system identify.

II. The system must be able to configure and reconfigure itself under varying and unpredictable conditions.

III. The system must never settle for the status quo and the system must always look for ways to optimize its workings.

IV. The system must be self-healing and capable of recovering from routine and extraordinary events that might cause some of its parts to malfunction.

V. The system must be an expert in self-protection.

VI. The system must know its environment and the context surrounding its activity, and act accordingly.

VII. The system must adhere to open standards.

VIII. The system must anticipate the optimized resources needed while keeping its complexity hidden from the user.

Notably, in accordance with the eight tenants of autonomic computing, several single system and peer-to-peer systems have been proposed in which self-configuration, management and healing have provided a foundation for autonomic operation. Yet, despite the eight tenants of autonomic computing, no existing implementation has addressed the need to efficiently and autonomically manage the administration of interdependent components in the enterprise. In particular, what remains at present is a purely manual system governed by hundreds of print pages of operations manuals for managing the network. The manuals generally specify actions to performed, the timing of those actions, and the persons authorized to perform such actions. Yet, the human enforcement of the rules specified by the operations manual has proven error prone and highly ineffective.

### SUMMARY OF THE INVENTION

The present invention is a systems administration policy enforcement system, method and apparatus. The present invention addresses the deficiencies of conventional systems administration in that the present invention overcomes the human error associated with the multiplicity of rules for administering any one resource in a system. In this regard, rather than requiring an administrator to refer to a voluminous set of printed manuals to determine the requisite state of related resources and the environment in general necessary to perform an administrative task, an administrative policy can be established which embodies the requisite state. A policy enforcement process can permit the administration of a resource in the system only when the requisite state of related resources and the environment comports with the rules of the policy.

In a method for enforcing the administration policy of a system in accordance with the present invention, a request to perform an administrative task directed to a resource within the computing network can be received. Responsive to receiving the request, an administration policy including a set of rules for governing the administrative task can be retrieved as can state data for the resource. Subsequently, the retrieved policy can be applied to the retrieved state data. Consequently, the administrative task can be permitted only if the retrieved state data satisfies the set of rules in the retrieved policy. Optionally, when a task is not permitted, the initiator of the task can be notified as to why permission to perform the task has been denied.

Importantly, the administration policy can be established by duly qualified administrators of the system, and in particular, by administrators of the various resources of the system. To that end, a user interface can be provided for establishing the set of rules for the administration policy. Once established, the policy can be stored the administration policy for subsequent retrieval in the retrieving step. The stored policy can consider not only the requisite state of the resource, but also environmental information for the system. The environmental information can range from the identification of the requesting administrator to one or more properties of the system's resources (such as, but not limited to, CPU utilization) to the time of day. In this regard, responsive to the request to administer the resource, the environmental information can be further retrieved for the computing network and the administrative task can be permitted only if the retrieved environmental data satisfies the set of rules in the retrieved policy.

Notably, the step of further retrieving the state data can include the step of retrieving state data both for the resource and also for other related resources in the computing network. To that end, the administrative task can be disallowed if the further retrieved state data fails to satisfy the set of rules in the retrieved policy either alone or in conjunction with other state data. Once disallowed, a related resource can be identified which has a state which gave rise to the state data for the resource which fails to satisfy the set of rules in the retrieved policy.

Significantly, upon identifying the related resource, a remediation of the condition in the related resource giving rise to the problematic state can be requested so that the state of the related resource ultimately satisfies the set of rules in the retrieved policy. Once the condition in the related resource has been remediated, the administrative task can be permitted. Importantly, the steps of disallowing, identifying, requesting and further permitting can be performed autonomically. Moreover, the steps of disallowing, identifying, requesting and further permitting can be performed recursively for each related resource whose state gives rise to a failure of the primary resource to satisfy the retrieved policy.

### BRIEF DESCRIPTION OF THE DRAWINGS

There are shown in the drawings embodiments which are presently preferred, it being understood, however, that the invention is not limited to the precise arrangements and instrumentalities shown, wherein:

FIG. 1 is a block illustration of system and method for performing policy based administration of a system in accordance with the inventive arrangements;

FIG. 2 is a schematic illustration of a policy evaluation component for use in the system of FIG. 1; and,

FIG. 3 is a flow chart illustrating a process for autonomically enforcing an administration policy in accordance with a specific, preferred aspect of the present invention.

### DETAILED DESCRIPTION OF THE PREFERRED EMBODIMENTS

The present invention is a system, method and apparatus for autonomic policy based systems management. In particular, in accordance with the present invention a set of policies can be established for the management of individual components in a system. As defined herein, components can include application components, software resources including application servers and databases relied upon by one or more of the application components, and hardware resources, including physical servers, communications bandwidth, disk storage and the like. Individual policies corresponding to individual components or combinations of individual components can establish rules which can constrain the management of the component.

The rules defined within the individual policies can include the identities of administrators authorized to undertake particular management operations, the timing of such operations, and most importantly, the requisite state both of the environment and other components required to undertake the particular requested management operation. Where the state of the environment and the other components does not meet the required state specified by the rules in the policy, the management operation can be disallowed. Alternatively, those components whose state inhibits the performance of a requested management operation can be autonomically managed so as to achieve the requisite state.

Specifically, in the autonomic configuration, when an administrator requests an action which subsequently becomes blocked by a rule in the pertinent policy, the blocking element can be resolved preferably without intervention by the administrator. As an example, in the event that a rule permits a database shutdown only once the database has undertaken an incremental backup procedure, a request to shutdown the database would become blocked until the backup procedure had occurred. Rather than simply block the request, though, the database can be notified of the requirement to undertake an incremental backup. Once the backup has occurred, the shutdown request can be honored.

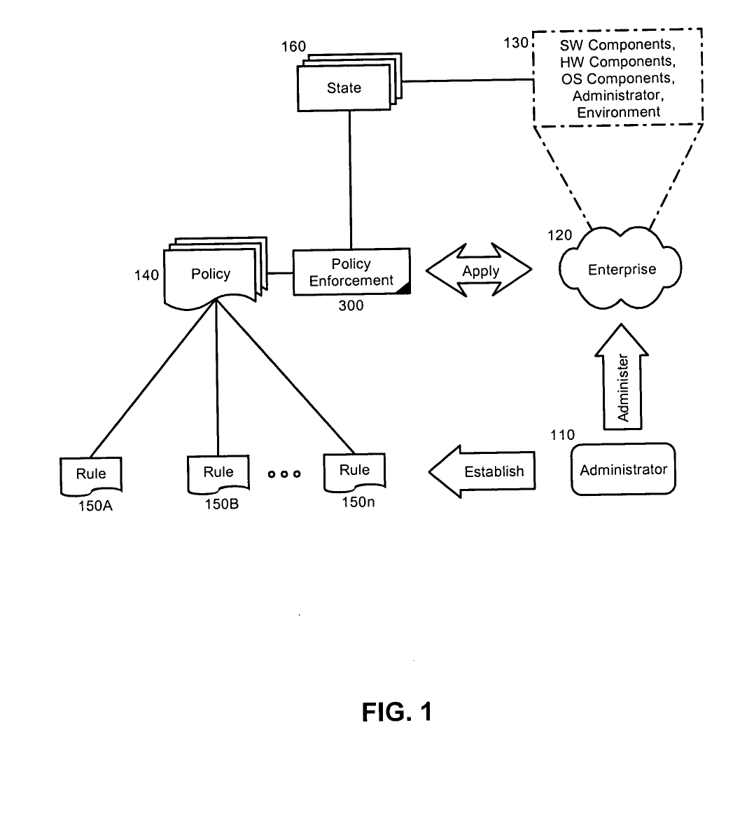

FIG. 1 is a block illustration of system and method for performing policy based administration of a system 120 in accordance with the inventive arrangements. The system of the present invention can include a set of rules 150A, 150B, 150n defining an administration policy 140. The policy 140 can specify the identities of administrators authorized to undertake particular management operations, the timing of such operations, and the requisite state both of the environment and other components required to undertake the particular requested management operation. The rules 150A, 150B, 150n in the policy can be established by any administrator and not merely an administrator performing a particular operation at any given time. A policy enforcement processor 300 can enforce the policy 140 responsive to a request to administer elements 130 within the system 120. Notably, such elements can include software and hardware components, operating system components, administrators authorized to manage elements of the enterprise, and the environment generally and of the system 120 itself.

In operation, an administrator 110 can establish the rules 150A, 150B, 150n of the policy 140. Subsequently, the administrator 110 (or another administrator or other user) can administer the system 120. By administer, it is meant that the administrator 110 can command the operation of one or more of the elements 130 of the system. Such commands can range from startup and shutdown operations, to query and configuration commands. In any case, the policy enforcement processor 300 can receive the administration command issued by the administrator 110. Responsive to the receipt of the administration command, the policy enforcement processor 300 can retrieve the pertinent rules 150A, 150B, 150n of the policy 140 which apply to the requested administration command. Additionally, the policy enforcement processor 300 can query and retrieve the state 160 of the pertinent elements of the system 120. Applying the retrieved pertinent rules 150A, 150B, 150n to the state 160, the policy enforcement processor 300 can determine whether requested administration command ought to be disallowed (blocked), or whether the requested administration command ought to be permitted.

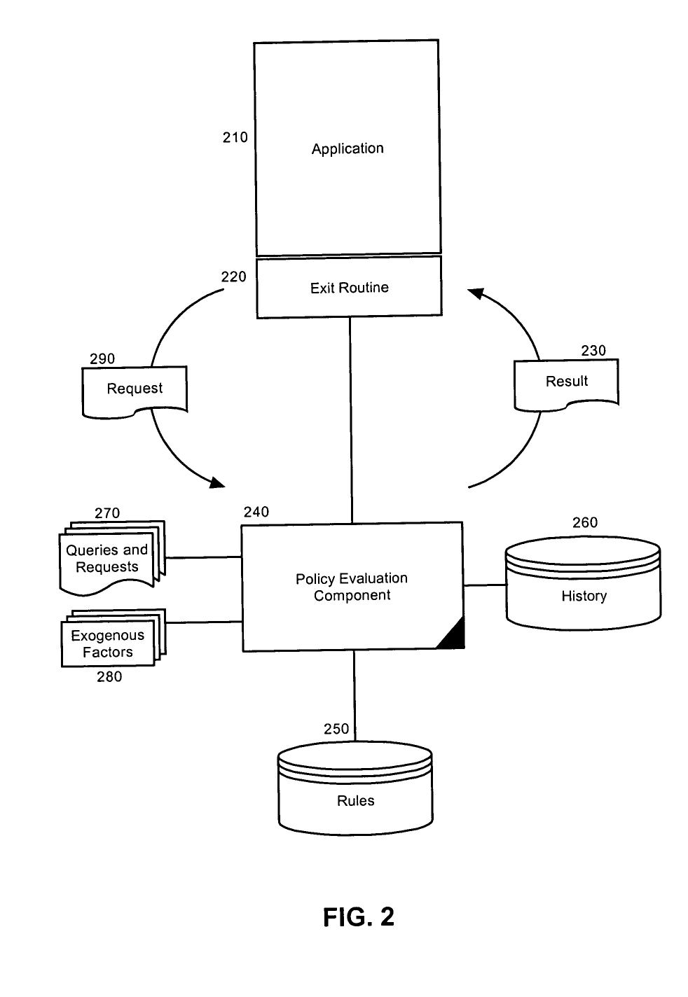

To facilitate the handling of requests to administer the system 120 of FIG. 1, each participating administerable one of the elements 130 (principally software and operating system components) can be configured to route administration requests to a policy enforcement processor, referred to hereafter as a “policy evaluation component”. FIG. 2 is a schematic illustration of a policy evaluation component 240 which has been configured for use in the system of FIG. 1. In accordance with the inventive arrangements, a participating application component 210 can be coupled to an exit routine 220. The exit routine 220, in particular, can be inserted into the administration console of the application 210. When an administrator initiates an action, an indicator of the action is passed to the policy enforcement component 240 in the form of a request 290. The request 290 can specify not only the nature of the action, but also identifying data suitable for use in authenticating the action in and of itself.

The policy evaluation component 240 can retrieve all applicable rules 250, for instance using a rules engine (not shown), such engine being well-known in the art. (An example includes the ABLE™ rules engine manufactured by IBM Corporation of Armonk, N.Y., United States of America) Through the rules engine, the policy evaluation component 240 can review the information required to evaluate the rules 250. The information can include, for instance, information passed on the initial request 290, subsequent queries of the requesting resource and requests to other resources, collectively 270, exogenous factors 280, and history 260, including both history stored at the policy evaluation component 240, and history stored else where in the system. The policy evaluation component 240 can evaluate the rules 250 in combination with the information to determine whether the action is permissible. If the action is permissible, the policy evaluation component 240 can return a result 230 to the exit routine 220 indicating whether the action is permitted.

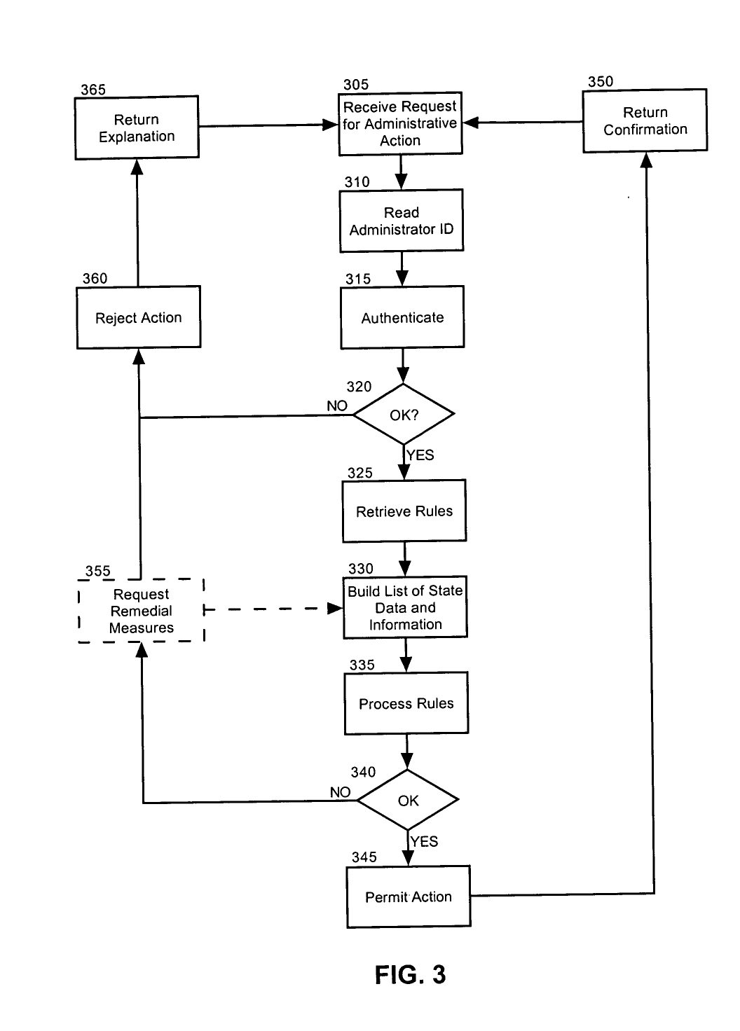

Importantly, rather than merely notifying the administrator whether a requested action is permitted, or whether the action has been blocked, the policy evaluation component 240 can request the remediation of the inhibiting elements of the network in an autonomic fashion. In this regard, FIG. 3 is a flow chart illustrating a process for autonomically enforcing a network administration policy in accordance in the policy enforcement processor 300 of FIG. 1. Beginning in block 305, a request for administrative action can be received. In block 310, the identification of the administrator can be retrieved from the request and in block 315, the administrator can be authenticated. If the identity of the administrator cannot be authenticated in decision block 320, the requested action can be rejected in block 360 with an associated explanation for the rejection having been concurrently forwarded to the administrator in block 365. Otherwise, the process can continue through block 325.

In block 325, a set of rules pertaining to the relevant policy can be retrieved for use in evaluating the request. In block 330, a list of state data for the system and other exogenous information, including historical logs and environmental elements (e.g. the time of day) can be constructed. In block 335, the rules can be applied to the list of state data and information to determine whether the action is permissible in view of the current state of the network. In block 340, if it is determined that the action is permissible, in block 345 the action can be permitted and a confirmation can be returned to the administrator in block 350. Otherwise, in block 355 remedial measures can be requested from the element of the network which has given rise to the blockage. Once the blockage has been remediated, the process can continue through blocks 330 through 350. If the blockage cannot be remediated, then in block 360 the action can be rejected and an explanation for the rejection can be forwarded to the administrator in block 365.

As an example, in the context of a request to shutdown a database, a pertinent set of rules in a network administration policy might specify that the database cannot be shutdown during working hours, while an application server remains connected to the database, prior to the performance of an incremental backup, and by anyone other than a specified database administrator. When an administrator requests a shutdown of the database, the exit routine of the console of the database component can trap the request, forwarding such request to a policy evaluation component. The policy evaluation component can retrieve the set of rules and associated state data and information. The state data and information can include, among other things, the identity of the administrator and the components coupled to the database, the time of day and the state of the database (e.g. the last time an incremental backup had been performed).

Initially, the policy evaluation component can determine whether the identity of the administrator is that of an authorized database administrator. If not, the request can be rejected and the administrator can be notified that the administrator lacks the relevant credentials to undertake a database shutdown operation. If the time of day falls within the impermissible working hours range, the request again can be rejected and the administrator can be notified that the administrator must wait until after working hours to perform a shutdown. If an application component remains coupled to the database, again the request can be rejected pending the decoupling of the application component from the database. Finally, if the database had not been incrementally backed up, the action can be rejected and a suitable explanation can be forwarded to the administrator.

Significantly, in the latter two circumstances, the policy evaluation component can attempt to resolve the blocking condition without significant intervention by the administrator. More particularly, in the case of a coupled application component, the policy evaluation component with or without the explicit approval of the administrator can forward a request to the coupled application to decouple itself from the database. Similarly, in the case of the incremental backup requirement, the policy evaluation component can forward a request to the database to perform an incremental backup. In both cases, the policy evaluation component can suspend the shutdown operation until the request criteria of the policy have been met. At that time, the policy evaluation component can resume the processing of the shutdown request without intervention by the administrator.

It will be recognized by the skilled artisan that the processing of autonomic requests by the policy evaluation component in response to blocking conditions in and of themselves can be processed autonomically in the same fashion as noted above in accordance with the rules of a pertinent policy. In this regard, the process of autonomically handling network administration tasks can be viewed as a recursive operation in which interdependent components are managed from the “bottom up”. Thus, it will be further apparent to the skilled artisan that the burdensome requirement of a network administrator to remain familiar and aware of all interdependent rules for network administration can be obviated by the autonomic processing of network administration commands through a set of predefined policy rules which can be processed in accordance with the inventive arrangements.

The present invention can be realized in hardware, software, or a combination of hardware and software. An implementation of the method and system of the present invention can be realized in a centralized fashion in one computer system, or in a distributed fashion where different elements are spread across several interconnected computer systems. Any kind of computer system, or other apparatus adapted for carrying out the methods described herein, is suited to perform the functions described herein.

A typical combination of hardware and software could be a general purpose computer system with a computer program that, when being loaded and executed, controls the computer system such that it carries out the methods described herein. The present invention can also be embedded in a computer program product, which comprises all the features enabling the implementation of the methods described herein, and which, when loaded in a computer system is able to carry out these methods.

Computer program or application in the present context means any expression, in any language, code or notation, of a set of instructions intended to cause a system having an information processing capability to perform a particular function either directly or after either or both of the following a) conversion to another language, code or notation; b) reproduction in a different material form. Significantly, this invention can be embodied in other specific forms without departing from the spirit or essential attributes thereof, and accordingly, reference should be had to the following claims, rather than to the foregoing specification, as indicating the scope of the invention.

1. A systems administration policy enforcement method comprising the steps of:
responsive to a request to perform an administrative task directed to a resource within a computing network, retrieving an administration policy comprising a set of rules for governing said administrative task, further retrieving state data for said resource and applying said retrieved policy to said retrieved state data; and,
permitting said administrative task only if said further retrieved state data satisfies said set of rules in said retrieved policy.

2. The method of claim 1, further comprising the steps of:
providing a user interface for establishing said set of rules for said administration policy; and,
storing said administration policy for subsequent retrieval in said retrieving step.

3. The method of claim 1, further comprising the steps of:
yet further retrieving environmental information for the computing network; and,
further permitting said administrative task only if said yet further retrieved environmental data satisfies said set of rules in said retrieved policy.

4. The method of claim 1, wherein said step of further retrieving said state data, comprises retrieving state data both for said resource and also for other related resources in said computing network.

5. The method of claim 1, further comprising the steps of:
disallowing said administrative task if said further retrieved state data fails to satisfy said set of rules in said retrieved policy;
identifying a related resource having a related resource state giving rise to said state data for said resource failing to satisfy said set of rules in said retrieved policy;
requesting remediation of said related resource state so that said related resource state satisfies said set of rules in said retrieved policy; and,
further permitting said administrative task subsequent to a remediation of said related resource state.

6. The method of claim 5, wherein said steps of disallowing, identifying, requesting and further permitting are performed autonomically.

7. The method of claim 5, wherein said steps of disallowing, identifying, requesting and further permitting are performed recursively for each related resource whose state gives rise to a failure of said resource to satisfy said retrieved policy.

8. The method of claim 1, further comprising the step of inserting an exit routine in an administration console of said resource, said exit routine having a configuration for forwarding requests to administer said resource to a policy evaluation component programmed to perform said steps of retrieving, further retrieving, applying and permitting.

9. A system administration policy enforcement system comprising:
an administration policy comprising a set of rules for permitting and disallowing administration of resources in a system hosting a plurality of interdependent resources;
a policy evaluation component configured to retrieve resource state data and determine whether said retrieved resource state data satisfies said set of rules in said administration policy; and,
an exit routine coupled to a resource in said network, said exit routine having logic for forwarding requests to administer said resource to said policy evaluation component.

10. The system of claim 9, further comprising a rules engine coupled to said policy evaluation component and configured to retrieve said set of rules on behalf of said policy evaluation component.

11. A machine readable storage having stored thereon a computer program for enforcing a systems administration policy, said computer program comprising a routine set of instructions for causing the machine to perform the steps of:
responsive to a request to perform an administrative task directed to a resource within a computing network, retrieving an administration policy comprising a set of rules for governing said administrative task, further retrieving state data for said resource, and applying said retrieved policy to said retrieved state data; and,
permitting said administrative task only if said further retrieved state data satisfies said set of rules in said retrieved policy.

12. The machine readable storage of claim 11, further comprising the steps of:
providing a user interface for establishing said set of rules for said administration policy; and,
storing said administration policy for subsequent retrieval in said retrieving step.

13. The machine readable storage of claim 11, further comprising the steps of:
yet further retrieving environmental information for the computing network; and,
further permitting said administrative task only if said yet further retrieved environmental data satisfies said set of rules in said retrieved policy.

14. The machine readable storage of claim 11, wherein said step of further retrieving said state data, comprises retrieving state data both for said resource and also for other related resources in said computing network.

15. The machine readable storage of claim 11, further comprising the steps of:
disallowing said administrative task if said further retrieved state data fails to satisfy said set of rules in said retrieved policy;
identifying a related resource having a related resource state giving rise to said state data for said resource failing to satisfy said set of rules in said retrieved policy;
requesting remediation of said related resource state so that said related resource state satisfies said set of rules in said retrieved policy; and,
further permitting said administrative task subsequent to a remediation of said related resource state.

16. The machine readable storage of claim 15, wherein said steps of disallowing, identifying, requesting and further permitting are performed autonomically.

17. The machine readable storage of claim 15, wherein said steps of disallowing, identifying, requesting and further permitting are performed recursively for each related resource whose state gives rise to a failure of said resource to satisfy said retrieved policy.

18. The machine readable storage of claim 11, further comprising the step of inserting an exit routine in an administration console of said resource, said exit routine having a configuration for forwarding requests to administer said resource to a policy evaluation component programmed to perform said steps of retrieving, further retrieving, applying and permitting.
